(19) United States
(12) Patent Application Publication
(10) Pub. No.: US 2019/0256039 A1
(43) Pub. Date: Aug. 22, 2019

(54) SYSTEMS AND METHODS FOR A SELF-ALIGNING RESTRAINT SYSTEM

(71) Applicant: GM GLOBAL TECHNOLOGY OPERATIONS LLC, Detroit, MI (US)

(72) Inventors: Richard L. Bruderick, Troy, MI (US); George J. Strnad, Rochester, MI (US); George Helou, Shelby Township, MI (US)

(73) Assignee: GM GLOBAL TECHNOLOGY OPERATIONS LLC, Detroit, MI (US)

(21) Appl. No.: 15/900,287

(22) Filed: Feb. 20, 2018

(51) Int. Cl. B60R 22/04; B60R 22/46

(52) U.S. Cl. CPC B60R 22/04; B60R 2022/3402; B60R 22/4604

(57) ABSTRACT

Systems and methods are provided for a restraint system. In one embodiment, a retractor assembly for a restraint system includes a retractor body defining a retractor axis and a retractor spool coupled to the retractor body. The retractor spool is configured to accept a retractor belt. A pivot component is configured to rotatably secure the retractor body to a mounting structure such that, when a loading force is applied to the retractor spool via the retractor belt, the retractor axis rotates to substantially align with the loading force.

### TECHNICAL FIELD

The present disclosure generally relates to vehicles, and more particularly relates to restraint systems safety belts used in such vehicles.

### BACKGROUND

Modern vehicles typically incorporate a wide range of restraint systems, such as belt restraints, head restraints, and the like. While belt restraints used in conjunction with such systems are highly effective, they still may be improved in a number of respects. For example, belt restraint retractor assemblies are typically rigidly attached to their respective mounting surfaces. As a result, the orientation of the belt webbing, when it is unspooled from the retractor, is fixed. Since the size and shape of an occupant may vary, however, the fixed orientation of the retractor can be unsatisfactory. And while it is possible to incorporate additional hardware such as guide loops into the retractor assembly to affect the apparent orientation of the belt webbing, such components add to manufacturing complexity and cost.

Accordingly, it is desirable to provide improved systems and methods for restraint systems in automotive vehicles and other moving platforms. Furthermore, other desirable features and characteristics of the present invention will become apparent from the subsequent detailed description and the appended claims, taken in conjunction with the accompanying drawings and the foregoing technical field and background.

### SUMMARY

Systems and methods are provided for improved restraint systems. In one embodiment, a retractor assembly for a restraint system includes a retractor body defining a retractor axis and a retractor spool coupled to the retractor body. The retractor spool is configured to accept a retractor belt. A pivot component is configured to rotatably secure the retractor body to a mounting structure such that, when a loading force is applied to the retractor spool via the retractor belt, the retractor axis rotates to substantially align with the loading force.

In one embodiment, the retractor assembly includes a rotation limiting assembly, for example, a pin component projecting from an undersurface of the retractor body, wherein the pin component is positioned to fit within a matching arcuate slot in the mounting structure. In one embodiment, the rotation limiting assembly limits rotation of the retractor body to a range of 0-30 degrees.

In one embodiment, the retractor body is configured such that the retractor axis corresponds to a default orientation when the loading force is not applied.

In one embodiment, the pivot component is a shoulder bolt coupling the retractor body to the mounting structure.

In one embodiment, the retractor assembly includes a vibration-reducing insert between the shoulder bolt and the retractor body.

In another embodiment, a vehicle includes a mounting structure provided within an interior portion of the vehicle and a retractor assembly coupled thereto. The retractor assembly includes a retractor body defining a retractor axis and a retractor spool coupled to the retractor body. The retractor spool is configured to accept a retractor belt. A pivot component is configured to rotatably secure the retractor body to a mounting structure such that, when a loading force is applied to the retractor spool via the retractor belt, the retractor axis rotates to substantially align with the loading force.

In one embodiment, the mounting structure is a shoulder retractor mount associated with a seat provided within the interior of the vehicle.

In one embodiment, the retractor assembly further includes a rotation limiting assembly, such as a pin component projecting from an undersurface of the retractor body, wherein the pin component is positioned to fit within a matching arcuate slot in the mounting structure. In one embodiment, the rotation limiting assembly limits rotation of the retractor body to a range of 0-30 degrees.

In one embodiment, the retractor body is configured such that the retractor axis corresponds to a default orientation when the loading force is not applied.

In one embodiment, the pivot component is a shoulder bolt coupling the retractor body to the mounting structure.

In one embodiment, the retractor assembly includes a vibration-reducing insert between the shoulder bolt and the retractor body.

In another embodiment, a method of forming a retractor assembly in a vehicle includes providing a retractor assembly including a retractor body defining a retractor axis, a retractor spool coupled to the retractor body, wherein the retractor spool is configured to accept a retractor belt. The method further includes rotatably coupling the retractor assembly to a mounting structure of the vehicle via a pivot component configured to rotatably secure the retractor body to the mounting structure at a default orientation; providing for rotation of the retractor assembly within a predetermined range in response to a force applied to the retractor belt; and automatically returning the retractor assembly to the default orientation.

In one embodiment, the mounting structure is a shoulder retractor mount associated with a seat provided within the interior of the vehicle.

In one embodiment, the retractor assembly further includes a rotation limiting assembly, such as a pin component projecting from an undersurface of the retractor body, wherein the pin component is positioned to fit within a matching arcuate slot in the mounting structure.

In one embodiment, the rotation limiting assembly limits rotation of the retractor body to a range of 0-30 degrees.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an exemplary vehicle having a system for detecting the state of a restraint system in accordance with various embodiments;

FIG. 2 illustrates occupants and restraints within the interior of a vehicle in accordance with an example embodiment;

FIGS. 3 and 4 are conceptual overviews illustrating the operation of a restraint assembly in accordance with various embodiments;

FIG. 5 illustrates a restraint assembly in accordance with one embodiment;

FIG. 6 is a flowchart illustrating a method in accordance with various embodiments.

### DETAILED DESCRIPTION

Systems and methods are described for a self-aligning restraint system for use in conjunction with an automotive vehicle or other moving platform in which such systems may be advantageously deployed.

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely one exemplary embodiments of the present disclosure.

For the sake of brevity, conventional techniques related to vehicle restraint systems, retractor assemblies, and vehicles in general, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

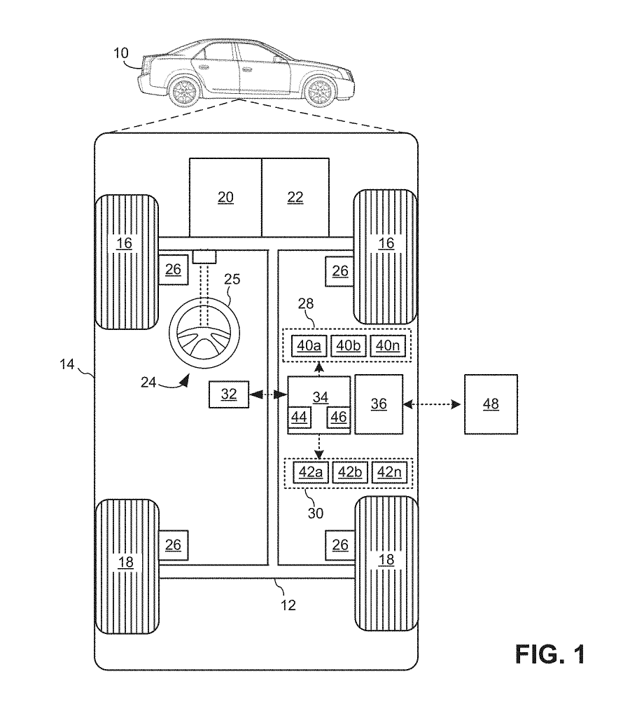

With reference to FIG. 1, a vehicle 10 employing a system in accordance with various embodiments generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. While the present systems and methods may be described in connection with an example, the range of embodiments are not so limited, and may be employed in connection with any moving platform that might advantageously incorporate such restraint systems, such as watercraft, aircraft, and the like. Stated another way, exemplary vehicle 10 is described without loss of generality.

In various embodiments, vehicle 10 is characterized by some level of autonomy. For example, vehicle 10 may correspond to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, construction detection systems in accordance with the present embodiment may be used in conjunction with any vehicle that utilizes a navigation system to provide route guidance. Furthermore, vehicle 10 may be a traditional, non-vehicle.

While vehicle 10 is depicted in the illustrated embodiment as a passenger car, it should be appreciated that any type of vehicle, including motorcycles, trucks, sport utility vehicles (SUVs), recreational vehicles (RVs), marine vessels, aircraft, and other movable platforms employing a restraint system may also employ the various methods and systems described herein.

Referring again to FIG. 1, vehicle 10 generally includes a propulsion system 20, a transmission system 22, a steering system 24, a brake system 26, a sensor system 28, an actuator system 30, at least one data storage device 32, at least one controller 34, and a communication system 36 for communicating with an external system 48. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the vehicle 10. The sensing devices 40a-40n might include, but are not limited to, radars, lidars, global positioning systems, optical cameras, thermal cameras, ultrasonic sensors, and/or other sensors. In various embodiments, sensing devices 40a-40n include sensors capable of sensing marker components embedded in belt restraints, head restraints, or the like, such as RF sensors capable of sensing the position and configuration of embedded metal marker components.

Actuator system 30 includes one or more actuator devices 42a-42n that control one or more vehicle features such as, but not limited to, the propulsion system 20, the transmission system 22, the steering system 24, and the brake system 26. In various embodiments, vehicle 10 may also include interior and/or exterior vehicle features not illustrated in FIG. 1, such as various doors, a trunk, and cabin features such as air, music, lighting, touch-screen display components (such as those used in connection with navigation systems), and the like.

The data storage device 32 stores data for use in automatically controlling vehicle 10. In various embodiments, data storage device 32 stores defined maps of the navigable environment. In various embodiments, the defined maps may be predefined by and obtained from a remote system. For example, the defined maps may be assembled by the remote system and communicated to the vehicle 10 (wirelessly and/or in a wired manner) and stored in the data storage device 32. Route information may also be stored within data device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10. In one embodiment, as discussed in detail below, controller 34 is configured to detect and classify the state of a restraint system incorporated into vehicle 10.

Communication system 36 is configured to wirelessly communicate information to and from other entities 48, such as but not limited to, other vehicles (“V2V” communication), infrastructure (“V2I” communication), remote transportation systems, and/or user devices. In an exemplary embodiment, communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

As can be appreciated, the subject matter disclosed herein provides certain enhanced features and functionality to what may be considered as a standard or baseline vehicle 10. To this end, a vehicle and vehicle based remote transportation system can be modified, enhanced, or otherwise supplemented to provide the additional features described in more detail below.

As mentioned above, systems and methods are described for detecting and classifying the state of a restraint system by embedding marker components (e.g., metallic fibers, strips, etc.) into belt restraints, head restraints, and the like, which are then observed by a sensor (e.g., an RF sensor) configured to determine the nature and spatial location of those embedded marker components within the interior of the vehicle.

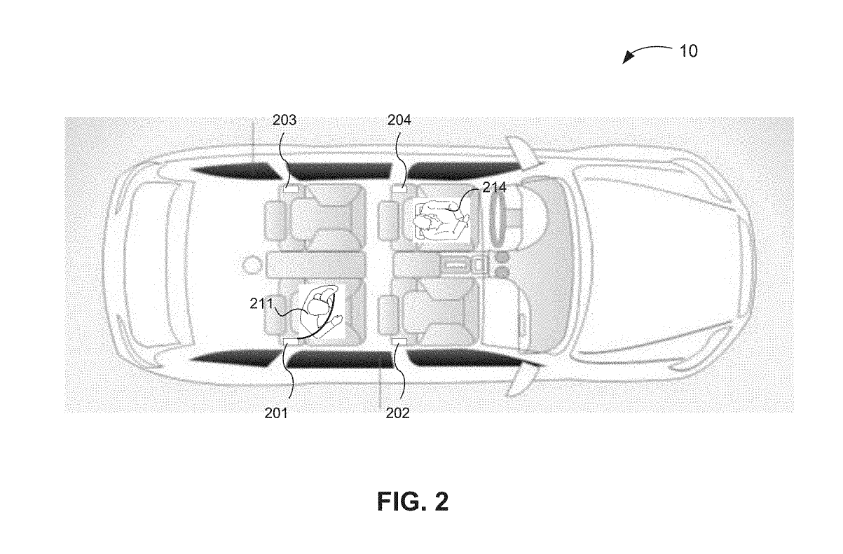

In that regard, FIG. 2 illustrates the interior of vehicle 10, highlighting various restraint system features that might be incorporated therein. Two occupants are illustrated, an occupant 211 located in the back seat, and a second occupant 214 seated in the front driver's seat. Also illustrated are various belt restraint assemblies 201-204 from which corresponding belt restraints can be deployed by an occupant. Occupant 211, for example, is shown as wearing a belt restraint 211. The number and location of such belt restraints may vary depending upon the design of vehicle 10, as is known in the art. The phrase “restraint system” is used herein to encompass any of the various components used to restrain, to some extent, an occupant during operation of vehicle 10. While the present disclosure focuses primarily on belt restraints of the type generally known as “shoulder” restraints, the invention is not so limited, and may be employed in the context of any restraint assembly in which self-alignment in response to a load may be advantageous.

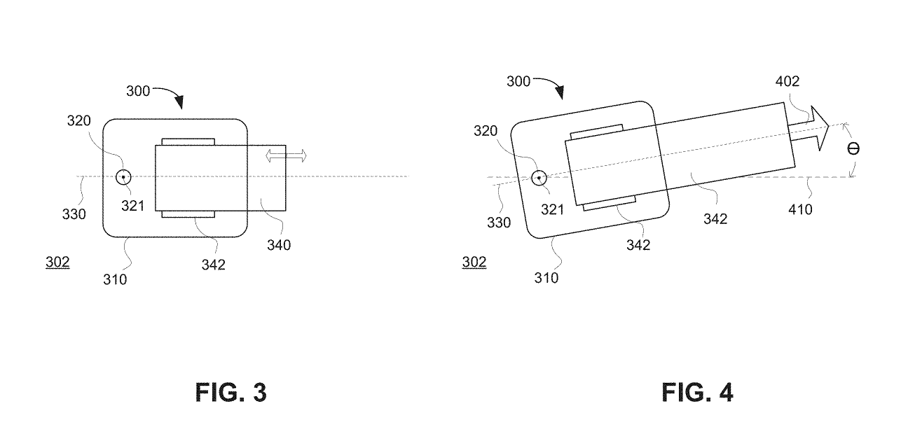

FIGS. 3 and 4 are conceptual overviews illustrating the operation of a restraint assembly in accordance with various embodiments. It will be appreciated that the figures are merely conceptual, and are in no way limiting with respect to the range of structural features that might be employed in various embodiments. Thus, for the sake of simplicity, additional components used in connection with belt restraints, such as tension reducers, pretensioners, load-limiters, buckles, tongue plates, and the like are not shown in the figures, but will be understood by a person skilled in the art.

With reference to FIG. 3, a retractor assembly (or simply “assembly”) 300 generally includes a retractor body (or simply “body”) 310 to which a retractor spool assembly (or simply “spool” 342) is coupled. Spool 342 is configured (using suitable spring components and the like) such that a retractor belt 340 may be selectively “payed out” from retractor assembly 300 or allowed to retract back into retractor assembly 300 by a passenger. That is, stated another way, retractor assembly (via spool 342) is configured to apply tension to belt 340 such that it stays snug against a passenger's body when it is deployed and latched (via a latching assembly not illustrated in the drawings), but retracts back into assembly 300 when it is unlatched and released by the passenger. A variety of retractor spool mechanisms may be used to implement spool 342, and accordingly such designs need not be described in detail herein. Similarly, the belt 340 may be fabricated using any material suitable for use for such belt restraints in modern vehicles, such as a “webbing” of woven polyester.

With continued reference to FIG. 3, retractor body 310 as well as spool 342 and belt 340 are shown as being coaligned along a retractor axis 330. That is, axis 330 represents the orientation of body 310 as well as any other components rigidly attached thereto. In general use, this would typically correspond to the default orientation of the retractor assembly 300 when not being utilized by a passenger (i.e., prior to belt 340 being unrolled from spool 342).

In accordance with various embodiments, retractor assembly 300 is rotatably mounted to a mounting surface (or other structure) 302 such that it rotates about a pivot point 321. That is, retractor body 310 and retractor spool 342 pivot together around point 321. Such that the retractor axis 330 can change, and is no longer fixed with respect to mounting surface 302. This rotation may be accomplished via the use of a suitable bolt or other pivot component 320, as discussed in further detail below.

As illustrated in FIG. 4, the ability for retractor assembly 300 to rotate about pivot point 321 allows assembly 300 to rotate to accommodate a loading force 402 applied to belt 342 that is not necessary collinear with the initial (or default) retractor axis 330 as shown in FIG. 3. That is, referring to FIG. 4, when a loading force 402 is applied to belt 342, the entire assembly (as well as belt 342) adjusts to accommodate the force, resulting in a retractor orientation (relative to a default axis 410) of an angle theta. That is, the retractor axis 330 rotates so that it substantially corresponds to the angle of the loading force 402.

It will be appreciated that the rotation of assembly of 300 is afforded not only by the presence of pivot component 320, but also by the fact that the pivot point 321 does not correspond to the center (as viewed from the top) of retractor spool 342. As a result, any loading force on belt 340 that is not parallel to axis 330 will result in a non-zero moment applied to assembly 300 such that assembly 300 will rotate to accommodate that force. In this regard, the distance (i.e., along axis 330 in FIG. 3) between pivot point 321 and retractor spool 342 may vary depending upon the available space for assembly 300 and other applicable design goals. In one embodiment, this distance is selected to provide from 1 to 30 degrees of rotation.

In some embodiments, retractor assembly 300 is configured (via the design of pivot component 320 and potentially other components) such that it will return to its default orientation (FIG. 3) when the loading force 402 is removed (and belt 340 is allowed to retract back into spool 342). This may be accomplished via springs, clips, and the like. In one embodiment, a coil spring of appropriate size is attached to the underside of the sheet metal mounting surface 302. The spring connects to a fixed point on the sheet metal and to the rotation pin 320 to hold them in tension in the default position. Tension applied to the seat belt 340 when pulled by the occupant (force 402) overcomes the tension of the spring and allow the retractor to align to the direction of pull. Once the tension is released, the spring allows the retractor 300 to rotate back to its default orientation. In other embodiments, retractor assembly 300 may rotate such that it does not return automatically to its default orientation.

Similarly, any suitable amount of friction may be incorporated into the system such that rotation of assembly 300 is impeded by some predetermined amount—e.g., to prevent assembly 300 from rotating on its own due to accelerations experienced during normal operation of the vehicle.

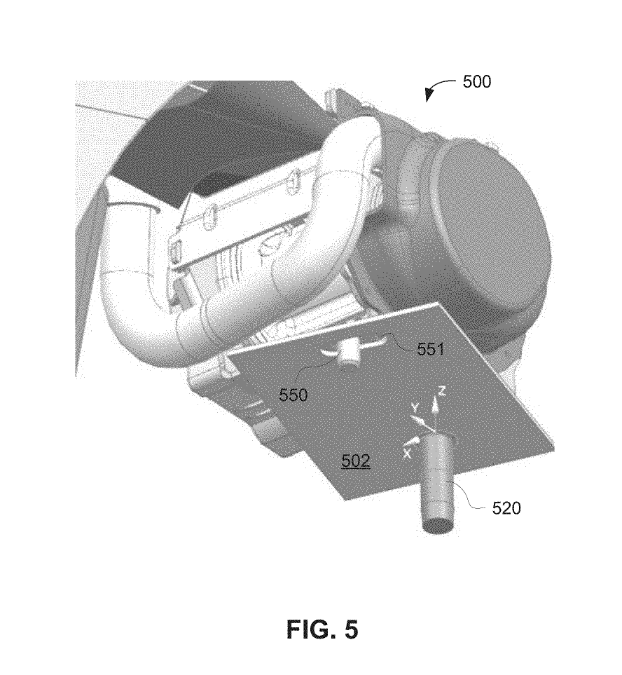

In some embodiments, the range of angles (theta in FIG. 4) through which retractor assembly 300 is allowed to rotate may be limited by pivot component 320 and/or other components incorporated into body 310 or mounting surface 302 (collectively referred to as a rotation limiting assembly). An example of such an embodiment will now be described in conjunction with FIG. 5.

Referring to FIG. 5, an example retractor assembly 500 (corresponding to assembly 300 in FIG. 3) is shown as viewed from the underside (i.e., from below a mounting structure 502, illustrated as a section of sheet metal). In this embodiment, the pivot component is implemented as an attachment bolt 520, and a structure projecting from the underside of the retractor assembly 500 (e.g., a pin 550, as shown) extends through an arcuate slot 551 such that rotation of assembly 500 relative to mounting structure 502 (and within a plane orthogonal to the rotational axis z in FIG. 5) is constrained. Pin 550 and slot 551 together constitute a rotation limiting assembly. The angle of constraint may vary, but in various embodiments allows less than 30 degrees of rotation.

In some embodiments, bolt 520 is threaded and is accepted by matching threads in mounting structure 502. In a particular embodiment, bolt 520 is a brass shoulder bolt designed to withstand a shear force of approximately 400 lbf. In some embodiments, various washers, spacers, and inserts are also incorporated to reduce vibration, friction, or the like. In one embodiment, a thin plastic, nylon, or other form of film is installed between the retractor body and the mounting 502 for such purposes.

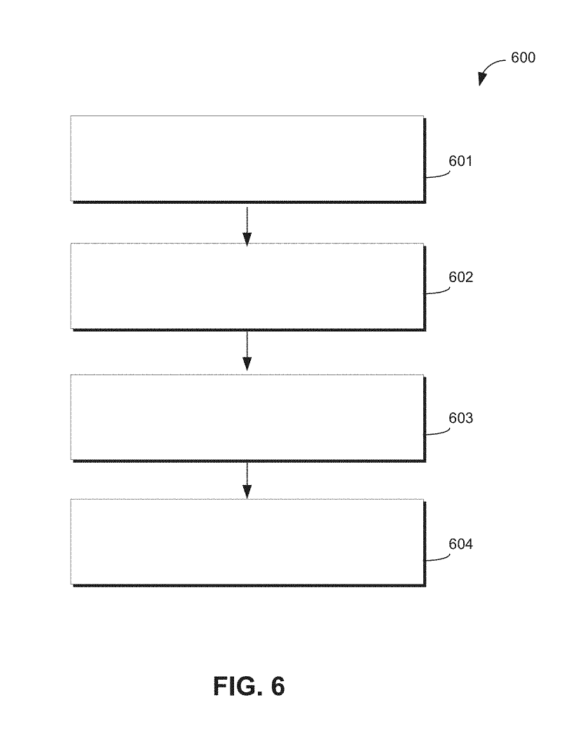

FIG. 6 is a flowchart illustrating a method 600 in accordance with various embodiments. In general, the process begins at 601, in which a retractor assembly is provided, including a retractor body, a retractor belt, and a retractor spool (e.g., as shown in FIG. 3). Next, at 602, the process includes rotatably coupling the retractor assembly to a mounting structure via a pivot component (e.g., a shoulder bolt as illustrated in FIG. 5) such that pivot component does not correspond to a center of the retractor spool and the retractor assembly is at a default orientation. At 604, the process includes providing for rotation of the retractor assembly within a predetermined range in response to a force applied to the retractor belt. Finally, at 605, the process includes automatically returning the retractor assembly to the default orientation.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A retractor assembly for a restraint system, comprising:
a retractor body defining a retractor axis;
a retractor spool coupled to the retractor body, the retractor spool configured to accept a retractor belt;
a pivot component configured to rotatably secure the retractor body to a mounting structure such that, when a loading force is applied to the retractor spool via the retractor belt, the retractor axis rotates to substantially align with the loading force.

2. The retractor assembly of claim 1, further including a rotation limiting assembly.

3. The retractor assembly of claim 2, wherein the rotation limiting assembly comprises a pin component projecting from an undersurface of the retractor body, wherein the pin component is positioned to fit within a matching arcuate slot in the mounting structure.

4. The retractor assembly of claim 2, wherein the rotation limiting assembly limits rotation of the retractor body to a range of 0-30 degrees.

5. The retractor assembly of claim 1, wherein the retractor body is configured such that the retractor axis corresponds to a default orientation when the loading force is not applied.

6. The retractor assembly of claim 1, wherein the pivot component is a shoulder bolt coupling the retractor body to the mounting structure.

7. The retractor assembly of claim 6, further including a vibration-reducing insert between the shoulder bolt and the retractor body.

8. A vehicle comprising:
a mounting structure provided within an interior portion of the vehicle;
a retractor assembly, the retractor assembly including a retractor body defining a retractor axis, a retractor spool coupled to the retractor body, wherein the retractor spool is configured to accept a retractor belt, and a pivot component configured to rotatably secure the retractor body to the mounting structure such that, when a loading force is applied to the retractor spool via the retractor belt, the retractor axis rotates to substantially align with the loading force.

9. The vehicle of claim 8, wherein the mounting structure is a shoulder retractor mount associated with a seat provided within the interior of the vehicle.

10. The vehicle of claim 8, wherein the retractor assembly further includes a rotation limiting assembly.

11. The vehicle of claim 10, wherein the rotation limiting assembly comprises a pin component projecting from an undersurface of the retractor body, wherein the pin component is positioned to fit within a matching arcuate slot in the mounting structure.

12. The vehicle of claim 10, wherein the rotation limiting assembly limits rotation of the retractor body to a range of 0-30 degrees.

13. The vehicle of claim 8, wherein the retractor body is configured such that the retractor axis corresponds to a default orientation when the loading force is not applied.

14. The vehicle of claim 8, wherein the pivot component is a shoulder bolt coupling the retractor body to the mounting structure.

15. The vehicle of claim 8, further including a vibration-reducing insert between the shoulder bolt and the retractor body.

16. A method of forming a retractor assembly in a vehicle, comprising:
providing a retractor assembly including a retractor body defining a retractor axis, a retractor spool coupled to the retractor body, wherein the retractor spool is configured to accept a retractor belt,
rotatably coupling the retractor assembly to a mounting structure of the vehicle via a pivot component configured to rotatably secure the retractor body to the mounting structure at a default orientation;
providing for rotation of the retractor assembly within a predetermined range in response to a force applied to the retractor belt; and
automatically returning the retractor assembly to the default orientation.

17. The method of claim 16, wherein the mounting structure is a shoulder retractor mount associated with a seat provided within the interior of the vehicle.

18. The method of claim 16, wherein the retractor assembly further includes a rotation limiting assembly.

19. The method of claim 18, wherein the rotation limiting assembly comprises a pin component projecting from an undersurface of the retractor body, wherein the pin component is positioned to fit within a matching arcuate slot in the mounting structure.

20. The method of claim 18, wherein the rotation limiting assembly limits rotation of the retractor body to a range of 0-30 degrees.
